(19) United States
(12) Patent Application Publication
(10) Pub. No.: US 2012/0136887 A1
(43) Pub. Date: May 31, 2012

(54) METHOD AND SYSTEM FOR PROVIDING MULTIFUNCTIONAL SEARCH WINDOW SERVICE BASED ON USER-GENERATED RULES

(76) Inventors: Myoung Geun Cha, Seoul (KR); Young Chul Cha, Los Angeles, CA (US)

(21) Appl. No.: 13/378,363

(22) PCT Filed: Oct. 24, 2009
(86) PCT No.: PCT/KR2009/006171

§ 371 Date: Feb. 13, 2012

(30) Foreign Application Priority Data
Jun. 15, 2009 (KR) 10-2009-0053111

(51) Int. Cl. G06F 17/30

(52) U.S. Cl. 707/767; 707/E17.066

(57) ABSTRACT

The present invention relates to a method and a system for providing a multifunctional search window (search box) service, and more specifically, to a method and a system which can provide a multifunctional search window service for offering search and shortcut services based on various search rules and shortcuts that are generated by users, and suggest recommended search words and recommended search rules when a certain query is inputted. To this end, the present invention provides a search window service system positioned on the front end of a conventional search engine or service server. The search window service system comprises: a search word recommendation DB used to recommend search words which are associated with a query inputted by users, a search rule recommendation DB used to recommend search rules which are used in association with the search words, a personal settings information DB for storing settings information of each user, a search window information DB for storing settings information of each search window, a search rule information DB for enabling the users to directly register search rules, and a shortcut DB for enabling the users to directly register shortcut information; a query recommendation module for helping the inputting of the search words and the search rules for the inputted query on the basis of the search word recommendation DB and the search rule recommendation DB; a settings information restoration module for classifying and restoring queries according to each element on the basis of the personal settings information DB and the search window information DB; a command analysis module for perceiving whether the classified and restored query is a command, and configuring messages to execute the corresponding commands; a message restoration module for converting the query which is classified and restored via the settings information restoration module or the command analysis module into the messages on the basis of the search rule information DB and the shortcut information DB; a redirection module for redirecting the message which is generated from the message restoration module or the command analysis module to the users by using the redirection method; a template module for returning the message which is generated from the message restoration module to the users by using the template method; and a proxy module for returning the message which is generated from the message restoration module to the users by using the proxy method.

### TECHNICAL FIELD

The present invention relates to a method and a system for providing a multifunctional search window service, and more specifically, to a method and a system which can provide a multifunctional search window service for offering search and shortcut services based on various search rules and shortcuts that are generated by users, and suggest recommended search words and recommended search rules when a certain query is inputted.

### BACKGROUND ART

The search results from a conventional search engine are limited by the coverage of the search engine. That is, when we search through Naver (Naver) by inputting a query in Naver's search window, we can only get the search results consisting of the web pages that Naver covers. However, as the Internet evolves and the amount of information grows exponentially, it becomes impossible for a single search engine to cover all the Internet. In recent years, though many people use Google which is well known for delivering good search results, the search results from Google are also limited by its coverage and it cannot surpass a specialized search engine in a specific field. For example, in the case of Blog (Blog), a Blog-specific search engine can deliver better search results than Google.

To solve this problem, Google introduced Google Custom Search (Custom Search) and enabled users to modify and tune weights for specific domains or sites; however, its search results are still generated by the Google search engine and are limited by Google's coverage; moreover, to use the Google Custom Search, users need to create their own search windows and input their queries to those search windows. In other words, users cannot use a variety of Custom Search configurations m a single search window; only one Custom Search is supported by one search window.

In addition, though Amazon (Amazon)'s A9, a open search service which displays search results from multiple search engines, was introduced to overcome the limited coverage of the search results from a single search engine, it requires pre-registration of favorite search engines, which is not easy for normal users; it also has a disadvantage of supporting only one search configuration in a single search window, like Google's Custom Search.

### SUMMARY OF INVENTION

### Technical Problem

To solve the above problems, the invention “Multi-function search window service method and system exploiting redirection message” was filed by the present inventor and registered; however, it is designed in the perspective of a service provider and does not have a structure to support user participation which becomes essential in today's web services. To solve the problem of the previous invention, the present invention allows users to register their own search rules; hence, the present invention can strengthen the scalability and provide more personalized service.

### Solution to Problem

The present invention is characterized by comprising; a search word recommendation DB utilized to recommend a search word associated with a query inputted by a user, a search rule recommendation. DB utilized to recommend a search rule in association with the inputted search word, a personal settings information DB storing settings information on a user basis, a search window information DB storing settings information for every search window, a search rule information DB enabling direct registration by users, and a shortcut information DB enabling direct registration by the users; a query recommendation module Which helps to input a search word and a search rule for the inputted query based on the search word recommendation DB and the search rule recommendation DB; a setup information restoration module which classifies and restores the query on an element basis based on the personal settings information DB and the search window information DB; a instruction analysis module which checks whether the classified and restored query is a command and constructs a message to perform a relevant command; a message restoration module which converts the query, classified and restored through the setup information restoration module or the instruction analysis module, into the message based on the search rule information DB and the shortcut information DB; a redirection module which redirects the message, generated from the message restoration module or the instruction analysis module, to the user in a redirection manner; a template module which returns the message, generated from the message restoration module, to the user in a template manner; and a proxy module which returns the message, generated from the message restoration module, to the user in a proxy mariner. The above search rule information DB is characterized by assigning a unique ID to each search rule registered in the search rule recommendation DB; it is also characterized by registering and saving reputation, usage, adoption count, existence of sponsor, and IP address. In addition, the above search rule information DB is characterized by discerning each search rule by assigning a unique ID; it is also characterized by saving reputation, usage, adoption count, existence of sponsor, and so on per each search rule; it is also characterized by saying and registering IP address per each search rule.

In the present invention, ‘at’ is registered with the personal settings information DB as a default separator, and symbols, such as ‘>>’, or letters, such as [symbol] can be registered with the personal settings information DB according to user selection.

In addition, the query recommendation module comprises the steps of: displaying a search word or a search rule, having a sponsor, at the top of a recommendation area based on the search word recommendation DB or the search rule recommendation DB in order to induce user selection; and when a user selects the search word or the search rule, storing the number of times of selection in the search word recommendation DB or the search rule recommendation DB on a sponsor basis.

In addition, the embodiment of search window service according to the present invention comprises an input step of receiving a query from a user, a settings information restoration step of classifying and restoring a completed query on an element basis based on a personal settings information DB and a search window information DB, a message restoration step of restoring the classified and restored query into a message based on a search rule information DB, and a step of returning the restored message to the user.

In addition, the input step comprises the step of receiving the completed query through the steps of: in the case that a search word recommended by a search word recommendation DB is selected in relation to a query inputted by the user or the input query includes only the search word, when search rules including a separator are recommended based on a search rule recommendation DB, if a default search rule registered with the personal settings information DB is selected among the recommended search rules, inputting the default search lute; if an adoption rule registered with the personal settings information DB is selected among the recommended search rules, inputting the relevant adoption rule; if a search rule other than the default search rune or the adoption rune is selected among the recommended search rules, inputting a search rule complying with a selection criterion registered with the personal settings information DB; and if any one of the recommended search rules is not selected, inputting the default search rule.

In addition, the settings information restoration step comprises the steps of: if a command is included in the restored query and the command is a shortcut command by analyzing the command, executing the shortcut command based on a shortcut information DB; and if the command is a command other than a shortcut command, executing the relevant command.

In addition, the settings information restoration step comprises: a step of: if the restored query does not include a separator and the default search rule set in the search window information DB exists in a search window, selecting the default search rule set in the search window; a step of, if the restored query does not include a separator and the default search rule does not exist in the search window, selecting the user's default search rule set in the personal settings information DB; a step of, if the restored query does not include a separator, the default search rule does not exist in the search window, and a user's default search rule is not set in the personal settings information DB, selecting a global default search rule; a message restoration step of, if the restored query includes a separator and a search rule next to the separator is not registered with the search rule information DB, restoring a message with the URL to the page where a new search rule is registered; a step of, if the restored query includes a separator, a search rule next to the separator is registered with the search rule information DB, and the relevant search rule selected by the user is stored in the personal settings information DB, selecting the search rule selected by the user; and a step of, if the restored query includes a separator, a search rule next to the separator is registered with the search rule information DB, and the user did not adopt the search rule, selecting a search rue based on a search rule selection criterion stored in the personal settings information DB.

In addition, the step of returning the restored message to the user comprises the steps of:

transmitting the search word from a search window service system to service servers, receiving responses and reorganize the responses, and transmitting the reorganized result to a screen of the user in a proxy manner:

generating and transmitting a template, directly receiving the responses from the service servers through a computer of the user, and displaying the result on the screen of the user in a template manner; and restoring the URL according to the search rule and displaying the restored URL on the screen of the user.

In addition, the message restoration step comprises the step of substituting a server address part of the URL with an IP address based on the personal settings information DB and transmitting the IP address.

### Advantageous Effects of Invention

According to the presented invention described above, in the users' perspective, users can easily use a variety of search rules and shortcuts accumulated by other users in the way of crowd sourcing (Crowd Sourcing); users can also adopt and use the most appropriate ones among many search rules and shortcuts having the same name by personalization feature. In addition, when users use the search words or search rules recommendation feature, users may benefit from the recommended search words or search rules related to the query based on usage or adoption count; hence, users can get desired search results more easily and fast,

In the search service provider's perspective, the search service provider providing this service can be more popular and influential by being selected as a default search engine of Internet Explorer or Firefox; it also leads to increased revenue in advertisement and effective handling of users' needs by analyzing search words statistics stored in the log DB. In addition, the search service provider can expect increased revenue from a variety of revenue models such as prioritized display of search words or search rules in recommendations and revenue sharing for the traffic to end sites.

### BRIEF DESCRIPTION OF DRAWINGS

FIG. 1 illustrates the structure of a search window service system according to the present invention.

FIG. 2 illustrates an example of processing a query inputted in the address bar using a redirection method by the search window service system according to the present invention.

FIG. 3 illustrates an example of processing a query inputted in the address bar using a template method by the search window service system according to the present invention.

FIG. 4 illustrates an example of processing a query inputted in the address bar using a proxy method by the search window service system according to the present invention.

FIG. 5 is a flowchart diagram illustrating a method of processing a query in the search window service system according to the present invention.

FIG. 6 is a flowchart diagram illustrating a method of selecting a search rule in the search window service system according to the present invention.

FIG. 7 is a diagram of two step recommendation of search words and search rules in an embodiment of the search window service system according to the present invention.

FIG. 8 shows examples of processing input queries by an embodiment of the search window service system according to the present invention.

### DESCRIPTION OF EMBODIMENTS

The detailed description on systems and methods of the present invention is provided with drawings.

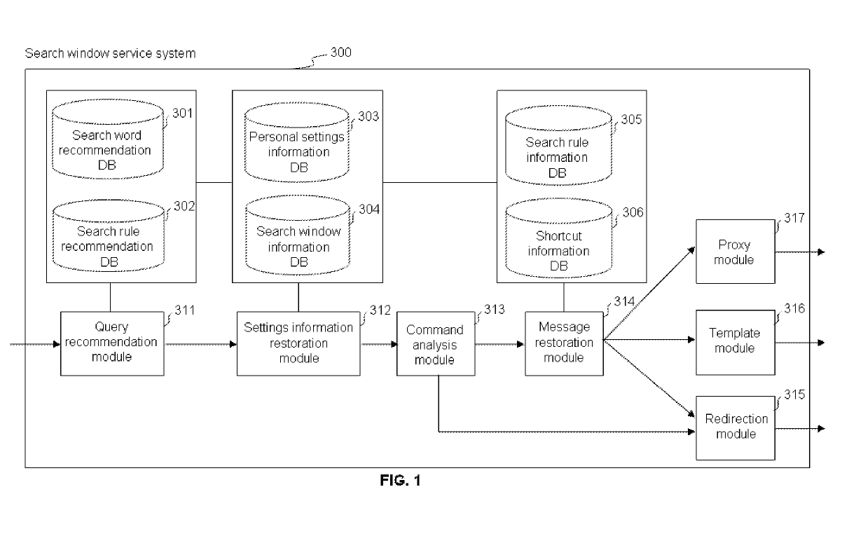

FIG. 1 illustrates the structure of a query analysis system. The query analysis system generates appropriate a message according to the query inputted in a search window. To do this, the inputted query goes through a query recommendation module, a setup information restoration module, a instruction analysis module, a message restoration module, a proxy module, a template module, and a redirection module; each module can refer to a search word recommendation. DB, a search rule recommendation DB, a personal settings information DB, a search window information DB, a search rule information DB, and a shortcut information DB if needed,

For example, let's assume that the query ‘mp3 at google’ is inputted at the search window. The intended action of this query is to search the query ‘mp3’ using the search engine represented by the search rule ‘google’ and to show the search results to the browser.

Firstly, the query recommendation module starts recommendations for the query ‘mp3’. When a user starts to input ‘m’ in the search window, the query recommendation module looks up the search word recommendation DB and displays words starting with ‘m’ such as ‘myspace’, ‘man’, and ‘mp3’ at the bottom of the search window, and this kind of recommendation is very common in many search engines.

In the case that the user selects ‘mp3’ among the recommended search words, the query recommendation module looks up the search rule recommendation DB and starts the second step recommendation; the second step recommendation recommends frequently used search rules by that user, frequently adopted search rules by all the users or recently popular search rules for the query ‘mp3’. If users use search rules such as ‘google’, ‘amazon’ or ‘itunes’ for the query ‘mp3’, those search rules will be recommended and displayed in the recommendations such as ‘mp3 at google’, ‘mp3 at amazon’ or ‘mp3 at itunes’. In each of the recommendations, ‘at’ is a separator separating a search word and a search rule; users can choose their own separators in personal settings information. Some users may use their own language specific separators like [symbol] or special characters like ‘>>’ instead of ‘at’.

In the above example, the terms search word and search rule are used just because the present service can be most useful in a search service; the present service is not limited to a search service and can be applied to any service which has parameter inputs. For example, the query ‘I am busy today at miniblog’ may post (Posting) the sentence ‘I am busy today’ to the micro blog named ‘miniblog’. In addition, the search rule does not need to have the same with the service; for example, the search rule ‘miniblog’ can be a rule posting to Twitter or a rule posting to Metoday, which is famous in Korea. In short, the user Who registers a search rule may choose his preferred name and there could be many search rules with the same name. The user decide which search rule to adopt (Adoption) in his personal settings information DB. The term adoption means the process of selecting a search rule among many search rules having the same name; the user can adopt one search rule for one name.

The setup information restoration module restores the original information for the user and the search window by looking up the personal settings information DB and the search window information DB. For example, when there is no specified search rule in a query, the default search rule for the user is used; a user whose default search rule is ‘google’ uses it for his default search and the other user whose default search rule is ‘naver’ uses it for his default search.

For the search rule ‘video’ in a query, if the user Who inputted the query has not adopted any rule having the name ‘video’ and there are two rules having the name ‘video’, one is searching videos in Youtube (www.youtube.com) and the other is searching videos in Naver Video (video.naver.com), the appropriate search rule is selected based on the user's selection criteria such as highest usage, highest adoption, highest reputation, existence of sponsor, and so on.

One of the reasons why we use the personal settings information DB and the search window information DB respectively is to separately handle the instant search window in the top right position of a browser and the search window positioned in a web page; in general, while the instant search window has no default search rule, the search window in a blog has a default search rule searching content inside that blog.

The setup information restoration module also restores a separator. As exemplified in the previous paragraph, there are some users who use ‘at’ and other users who use ‘>>’; the setup information restoration module find a separator in an input query.

The instruction analysis module in the present service processes commands such as /login, /logout, /default, /list, /go, and so on. Brief explanations on each commands are: ‘/login username’ redirects the user with the user name ‘username’ to the login page where he can input a password (Password); ‘/logout’ redirects the user who is currently logged in to the log out page after making him log out, ‘/default rulename’ sets the search rule with the name ‘rulename’ as a default search rule and ‘/list rulename’ displays the search rules with the name ‘rulename’, ‘/go shortcutname’ redirects the user to the address where the shortcut with the name ‘shortcutname’ points to.

The message restoration module restores the original message by looking up the search rule information DB and the shortcut information DB, based on the selected search rule or the shortcut restored by the settings information module described above. The difference between the search rule information DB and the shortcut information DB is the difference of the messages stored in each DB; the search rule information DB stores URL or code (Code) messages which requires a parameter (Parameter) like a search word and the shortcut information DB stores URL messages which does not require a parameter. The difference between the URL and the code is complexity; while the URL can specify only one service server, the code can specify multiple service servers; moreover, the code can specify the structure of the template and even contain a program executed by the query analysis system,

As an easy example, the ‘http://www.google.com/search?query=TEST’ is stored for the search rule ‘google’ in the search rule information DB and the ‘TEST’ will be replaced with the inputted parameter. In other words, the query ‘mp3 at google’ is translated into ‘http://www.google.com/search?query=mp3’ and transferred to Google for a search. On a while, the URL ‘http://www.google.com’ is stored for the shortcut ‘google’ in the shortcut information DB and there is no place for the inputted parameter. In other words, the command ‘/go google’ is translated into ‘http://www.google.com’ for a redirection.

During the translation process of search rule and shortcut, if the URL ‘http://www.google.com’ is sent to a client, the client looks up a DNS server to get the IP address for ‘www.google.com’ and it may cause delay; to reduce this delay, storing the IP address for ‘www.google.com’ in the search rule information DB in advance and using the IP address, e.g. ‘http://74.125.127.103’ instead of ‘http://www.google.com’, can be considered. However, in this scheme, users may have difficulty in discerning if the current site is an original site or a phishing site.

There are 3 methods of implementing how to show search results for user's query: a method of using a redirection message, a method of generating and transferring a result page template, and a method of reorganizing a result page as a proxy.

Firstly, the method of using a redirection message is the easiest method and is processed by the redirection module. As exemplified previously, in this method, the user's query ‘mp3 at google’ is translated into the URL ‘http://www.google.com/search?query=mp3’ and redirected to Google. The advantages of this method are reduced load for the query analysis system and easiness of creating search rules for users. However, it is hard to reorganize the search results according to user's needs (Needs.).

Secondly, the method of generating and transferring a result page template supports the reorganization of the search results while minimizing the load of the query analysis system, and is processed by the template module. For example, when the result page consists of 3 frame areas, the first area displays advertisements from Overture (www.overture.com), the second area displays the search results from Google, and the third page displays the search results from Naver (www.naver.com). For this method, public API (Application Programming Interface) is usually used.

Lastly, the method of reorganizing a result page as a proxy can reorganize the result page as needed though the load for the query analysis system is higher; it is processed by the proxy module. Different from the method of generating and transferring a result page template, which only divides the display area into multiple frames and filling in frames is done by the browser, the method of reorganizing a result page as a proxy let the query analysis system provide the contents in frames as well as the frame structure. Thus, though the load for the query analysis system increases it is possible to reorganize the search result as much as needed. The query analysis system according to the present invention is characterized by being able to use the proper one among all 3 supported methods, according to users' needs,

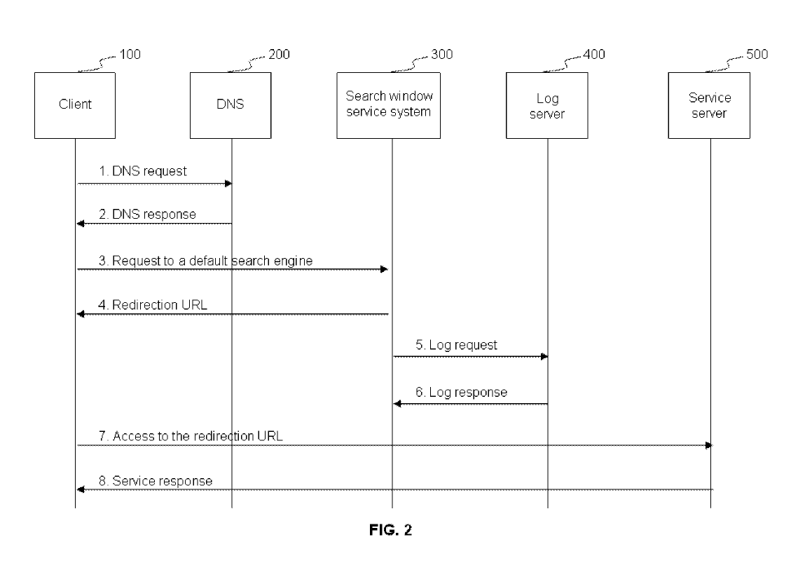

FIG. 2 illustrates a diagram of processing a query inputted in the address bar by the query analysis system using the redirection method. In the case of the query inputted in the address bar, it is transferred to DNS (Domain Name Service) server to verify if the query is a valid address. If the query is a valid address, it responses with the converted IP address and the client is redirected to the IP address; if the query is not a valid address, it responses with the message saying that the query is not an address and the client performs a search with the default search engine of the browser.

In this case, the default search engine can be set by the user; if the query analysis system is specified as the default search engine, the query analysis system analyzes the input query and sends the redirection message which redirects the browser to a proper service server. In addition, by storing the analyzed input query in an internal or external log DB during this process, the stored data can be used for creation of the search word recommendation DB and the search rule recommendation DB, generation of statistics for popular search words, and so on. If the user uses the instant search window of a browser or the search window on a web page instead of the address bar, the third process (sending the input query to the default search engine) of FIG. 2 will be the first process without doing the first (DNS server request) and the second (DNS server response) process.

Though the above query can be inputted through either the search window on a web page located in the server Where the query analysis system is implemented or the search window linked from an external server, if the query is inputted through the address bar or the instant search window of the browser, as described above, the use of the query analysis system will be greatly increased. In addition, it is possible to receive the query from either the search tool bar of portal sites like Yahoo (Yahoo) and Naver or the search window of operating system like Windows 7. In short, the query analysis system can be operated with any type of search window.

In addition, though the query analysis system can be implemented in a new site different from the current search engine sites or service sites, it can also be integrated into the current search engines.

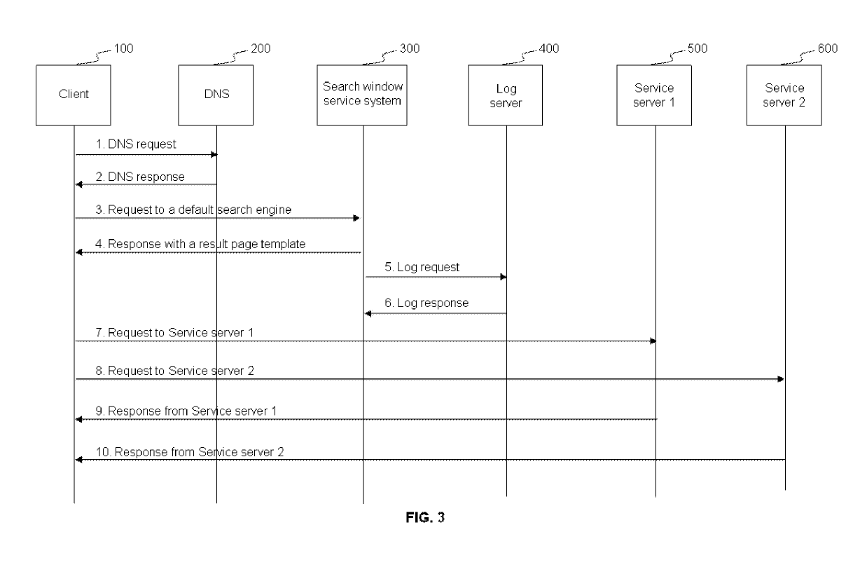

FIG. 3 illustrates a diagram of processing a query inputted in the address bar by the query analysis system using the method of generating and transferring a result page template. Different form the method of generating a redirection message in FIG. 2, when this method is used, it is possible to reorganize the result in the client by getting search results from multiple servers. The query analysis system sends the client the result page template and the client accesses each server to fill in each frame in the template.

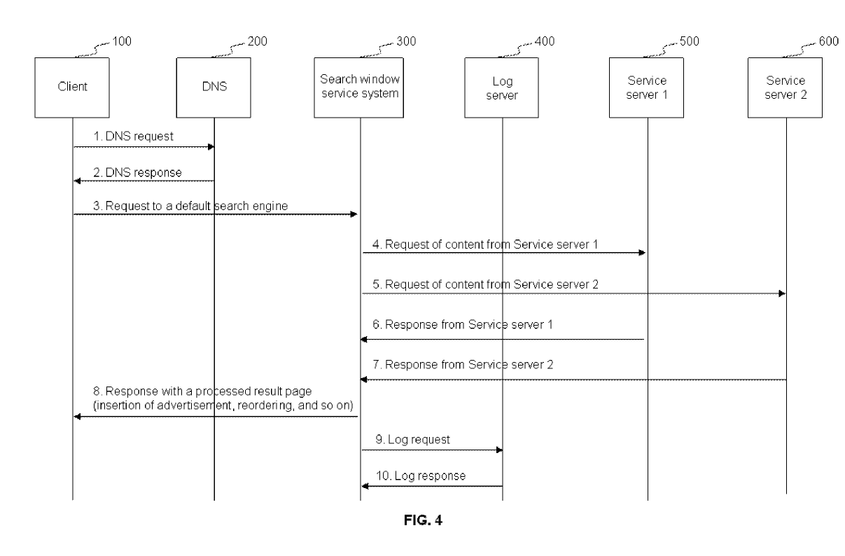

FIG. 4 illustrates a diagram of processing a query inputted in the address bar by the query analysis system using the method of reorganizing a result page as a proxy. Different form the method of generating a result page template in FIG. 3, when we reorganize a result page as a proxy, it is not the client but the query analysis system to send a query to each server and reorganize the result page. Thus, it is characterized by being able to reorganize the search results as needed.

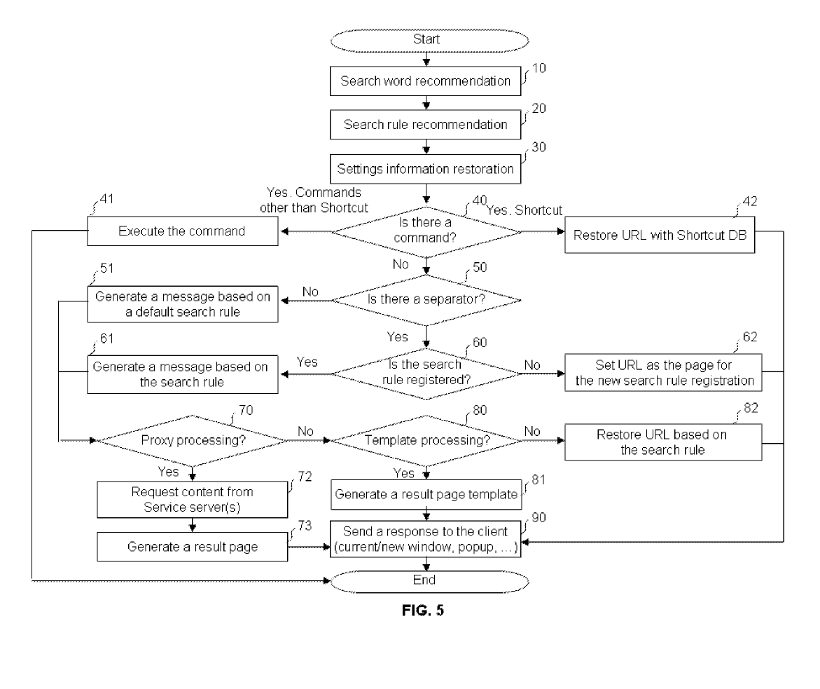

FIG. 5 illustrates a flowchart diagram of the query analysis system. Firstly, search word recommendation is performed for the inputted query, and search rule recommendation is performed after the search word recommendation. Then, the settings information restoration process is performed and the default search rule or the separator is selected for the use and the search window. If there is a designated command in the analyzed query, a pre-defined job is performed for the command; if the command is in the form of ‘go shortcutname’, URL restoration is performed using the shortcut information DB.

After the command analysis, the existence of a separator is checked; if there is no separator, message generation such as the URL restoration and the code generation is performed for the user and the search window; if a search rule is specified, the search rule is checked if it is registered or not. In this process, if the search rule is registered, a message such as a URL and a code is generated based on the search rule; if the search rule is not registered, the URL for a new search rule registration page is selected to redirect the user to the page.

The message generated with the search rule is transferred differently based on which method is used among the proxy method, the template method, and the redirection method. If the proxy method is selected, the proxy module of the query analysis system transfers the search word to the servers specified in the message, reorganize the result and display it to the user screen. When displaying it, the possible display methods are: displaying at the current window, displaying at a new window, displaying at a popup window, and so on; the preferred display method can be stored in the personal settings information DB per user or in the search rule information DB. In addition, the second separator such as ‘to’ can be used to specify a display method in a input query; ‘mp3 at google to new’ may mean searching ‘mp3’ with the search rule ‘google’ and displaying the result to a new window.

If the display method is not the proxy method, the template method is Checked; if the display method is the template method, a result page template is generated and transferred to the browser and the browser does the rest of the process.

If the display method is neither the template method nor the proxy method, the redirection method is selected; the redirection method is the simplest method; if the restored URL is transferred to the browser, the browser accesses the URL.

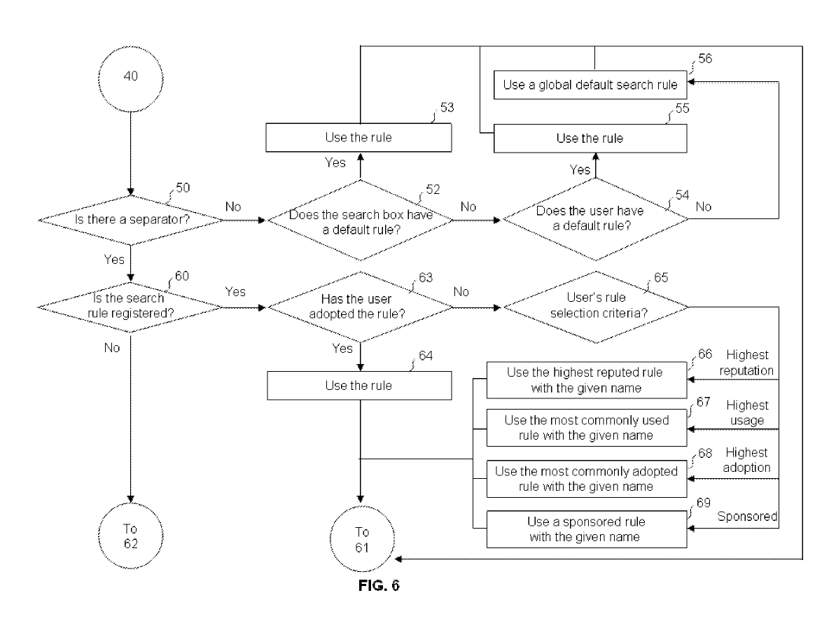

FIG. 6 is a flowchart diagram of selecting a search rule; it illustrates in detail the process of checking the existence of the separator and selecting a search rule while checking the existence of a search rule.

Firstly, if there is no separator in the input query, the query should be searched using the default search rule; to select the default search rule, the existence of the default search rule of the search window is checked first and if there is one, that rule is selected as the default search rule; if there is no default search rule for the search window, user's default search rule is selected as the default search rule. If it is not possible to identify the user or he has not specified his default search rule, the global default search rule is selected. At this step, different search rules can be specified for different regions; for example, Naver, the most popular search engine in Korea, may be selected for Korea and Google may be selected for other regions.

In the case that there is a search rule in an input query and the rule is registered, if there are more than one search rules having the name of that search rule, it is checked if the user has already adopted one among them; if it is the case, the adopted search rule is selected; if it is not, a search rule is selected based on user's search rule selection criterion. If the user's selection criterion is highest reputation, the search rule with the highest reputation is selected among the rules having the same name; if the user's selection criterion is highest usage, the search rule with the highest usage is selected among the rules having the same name. In addition, if the user's selection criterion is highest adoption, the search rule with the highest adoption count is selected among the rules having the same name; if the user's selection criterion is sponsored, the search rule with a sponsor is selected among the rules having the same name. For example, when there are two search rules having the name ‘a’, each from Amazon (www.amazon.com) and About (www.about.com), if About pays sponsoring fee for the name About's search rule will be selected even though Amazon's rule has been used more.

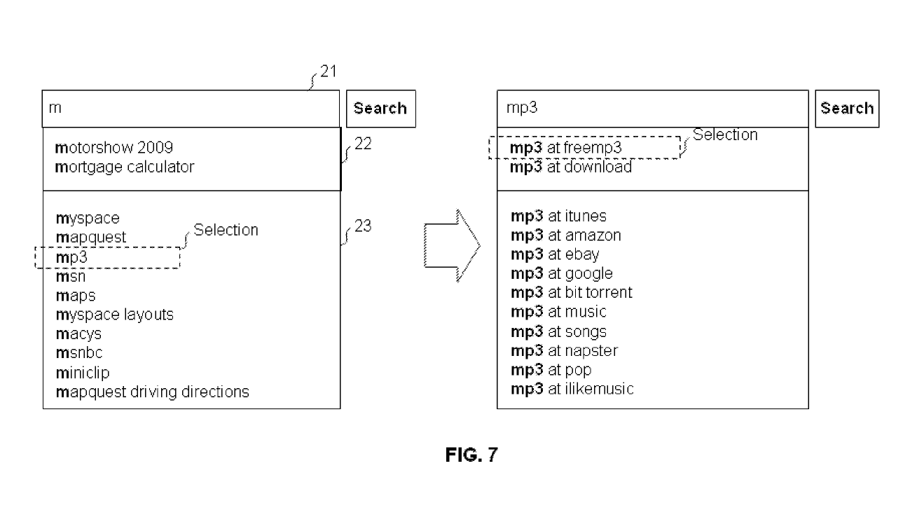

FIG. 7 illustrates an example of two step recommendation of search words and search rules in the query analysis system. When a user inputs ‘m’ in a search window, the query recommendation module looks up search word recommendation DB and displays multiple search words starting with ‘m’; at this step, there can be a sponsor area in the top of the display area where sponsor's search words are displayed. If one of the recommended search words is selected, search rules for the search word are recommended by looking up the search rule recommendation DB. It is possible by analyzing the number of associations between search words and search rules in the logs stored in the log DB and can be implemented with AJAX (Asynchronous Java Script and XML). Even in the case of the search rule recommendation, sponsor's search rule can be displayed at the top of the search rule recommendation area. Based on the stored number of times sponsor's search words and search rules are recommended in the search word recommendation DB and the search rule recommendation DB, sponsor may pay for the recommendation fee.

When search words and search rules are recommended, the number of associations between search words and search rules can he used; most commonly used search words or search rules per user or per search window can also be used for recommendation.

Each of the two steps can he performed separately or together. In short, the search word recommendation can be provided solely as in most other search engines; the search rule recommendation can also be provided solely; or both recommendations can be provided together. In addition, when a user selects sponsor's search word or search rule, a sponsor may pay for the recommendation fee.

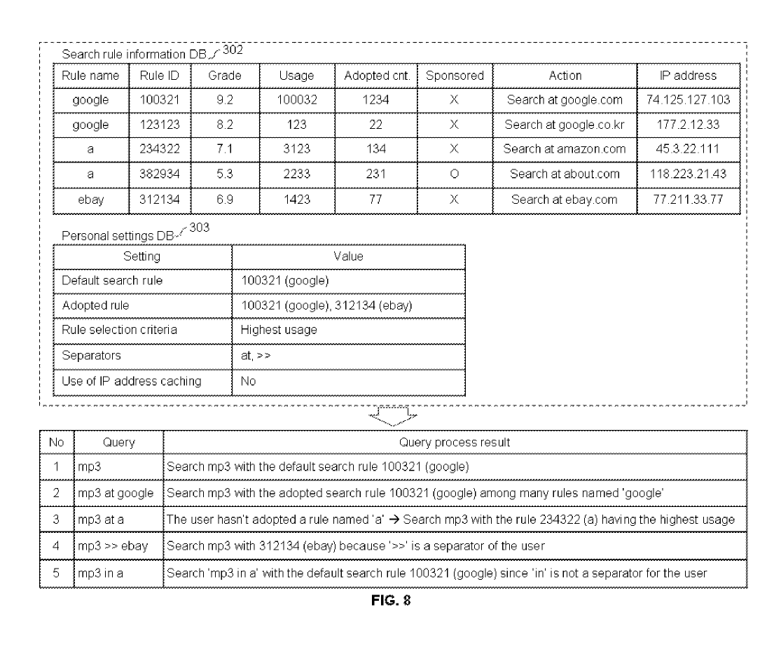

FIG. 8 illustrates examples of processed queries by the search window service system. The search rule information DB has the columns search rule name and search rule ID, which is unique to every search rule. In addition, there are columns like reputation, usage, adoption count, and existence of sponsor, which are used as selection criteria; there is a column describing the action caused by the search rule, usually represented with a URL or a code; there is also the IP address of the service server to reduce the step of the DNS look up.

The personal settings information DB contains user's default search rule ID, adopted search rule ID, selection criterion, separator, use of IP address, and so on.

The first query ‘mp3’ has no specified search rule; a search is performed using user's default search rule, google, whose ID is 100321. The name of the search rule of the second query ‘mp3 at google’ is google; among the search rules having the name google, the search rule with the ID 100321 is used for the second query; since the user has not adopted a search rule with the name a, for the third query ‘ma3 at a’, the search rule with the ID 234322 is selected based on the user's selection criterion, ‘highest usage’. In the fourth query ‘mp3>>ebay’, ‘>>’ is the separator the user has selected and the search rule with the ID 312134 having the name ebay is selected; in the case of the fifth query ‘mp3 [symbol] a’, the search with the query ‘mp3 [symbol] a’ is performed using the default search rule of the ID 100321, since the user has not selected ‘ [symbol] ’ as his separator. When the separator like at is a part of search words, the separator can be escaped with some special characters like double quotation marks; for example, in the query ‘education “at” Harvard at google’, the first at is not a separator.

The detailed description on systems and methods of the present invention is provided with drawings.

FIG. 1 illustrates the structure of a query analysis system. The query analysis system generates appropriate a message according to the query inputted in a search window. To do this, the inputted query goes through a query recommendation module, a setup information restoration module, a instruction analysis module, a message restoration module, a proxy module, a template module, and a redirection module; each module can refer to a search word recommendation DB, a search rule recommendation DB, a personal settings information DB, a search window information DB, a search rule information DB, and a shortcut information DB if needed.

For example, let's assume that the query ‘mp3 at google’ is inputted at the search window. The intended action of this query is to search the query ‘mp3’ using the search engine represented by the search rule ‘google’ and to show the search results to the browser.

Firstly, the query recommendation module starts recommendations for the query ‘mp3’. When a user starts to input ‘m’ in the search window, the query recommendation module looks up the search word recommendation DB and displays words starting with ‘m’ such as ‘myspace’, ‘man’, and ‘mp3’ at the bottom of the search window, and this kind of recommendation is very common in many search engines.

In the case that the user selects ‘mp3’ among the recommended search words, the query recommendation module looks up the search rule recommendation DB and starts the second step recommendation; the second step recommendation recommends frequently used search rules by that user, frequently adopted search rules by all the users or recently popular search rules for the query ‘mp3’. If users use search rules such as ‘google’, ‘amazon’ or ‘itunes’ for the query ‘mp3’, those search rules will he recommended and displayed in the recommendations such as ‘mp3 at google’, ‘mp3 at amazon’ or ‘mp3 at itunes’. In each of the recommendations, ‘at’ is a separator separating a search word and a search rule; users can choose their own separators in personal settings information. Some users may use their own language specific separators like [symbol] or special characters like ‘>>’ instead of ‘at’.

In the above example, the terms search word and search rule are used just because the present service can he most useful in a search service; the present service is not limited to a search service and can be applied to any service which has parameter inputs. For example, the query ‘I am busy today at miniblog’ may post (Posting) the sentence ‘I am busy today’ to the micro blog named ‘miniblog’. In addition, the search rule does not need to have the same with the service; for example, the search rule ‘miniblog’ can be a rule posting to Twitter or a rule posting to Metoday, which is famous in Korea. In short, the user who registers a search rule may choose his preferred name and there could be many search rules with the same name. The user decide which search rule to adopt (Adoption) in his personal settings information DR. The term adoption means the process of selecting a search rule among man search rules having the same name; the user can adopt one search rule for one name.

The setup information restoration module restores the original information for the user and the search window by looking up the personal settings information DB and the search window information DB. For example, when there is no specified search rule in a query, the default search rule for the user is used; a user whose default search rule is ‘google’ uses it for his default search and the other user whose default search rule is ‘naver’ uses it for his default search.

For the search rule ‘video’ in a query, if the user who inputted the query has not adopted any rule having the name ‘video’ and there are two rules having the name ‘video’, one is searching videos in Youtube (www.youtube.com) and the other is searching videos in Naver Video (video.naver.com), the appropriate search rule is selected based on the user's selection criteria such as highest usage, highest adoption, highest reputation, existence of sponsor, and so on.

One of the reasons why we use the personal settings information DB and the search window information DB respectively is to separately handle the instant search window in the top right position of a browser and the search window positioned in a web page; in general, while the instant search window has no default search rule, the search window in a blog has a default search rule searching content inside that blog.

The setup information restoration module also restores a separator. As exemplified in the previous paragraph, there are some users who use ‘at’ and other users who use ‘>>’; the setup information restoration module find a separator in an input query.

The instruction analysis module in the present service processes commands such as /login, /logout, /default, /list, /go, and so on. Brief explanations on each commands are: ‘/login username’ redirects the user with the user name ‘username’ to the login page where he can input a password (Password); ‘/logout’ redirects the user who is currently logged in to the log out page after making him log out. ‘/default rulename’ sets the search rule with the name ‘rulename’ as a default search rule and ‘/list rulename’ displays the search rules with the name ‘rulename’, ‘/go shortcutname’ redirects the user to the address where the shortcut with the name ‘shortcutname’ points to.

The message restoration module restores the original message by looking up the search rule information DB and the shortcut information DB, based on the selected search rule or the shortcut restored by the settings information module described above. The difference between the search rule information DB and the shortcut information DB is the difference of the messages stored in each DB; the search lute information DB stores URL or code (Code) messages which requires a parameter (Parameter) like a search word and the shortcut information DB stores URL messages which does not require a parameter. The difference between the URL and the code is complexity; while the URL can specify only one service server, the code can specify multiple service servers; moreover, the code can specify the structure of the template and even contain a program executed by the query analysis system.

As an easy example, the URL ‘http://www.google.com/search?query=TEST’ is stored for the search rule ‘google’ in the search rule information DB and the ‘TEST’ will be replaced with the inputted parameter. In other words, the query ‘mp3 at google’ is translated into ‘http://www.google.com/search?query=mp3’ and transferred to Google for a search. On a while, the URL ‘http://www.google.com’ is stored for the shortcut ‘google’ in the shortcut information DB and there is no place for the inputted parameter. In other words, the command ‘go google’ is translated into ‘http://www.google.com’ for a redirection.

During the translation process of search rule and shortcut, if the URL ‘http://www.google.com’ is sent to a client, the client looks up a DNS server to get the IP address for ‘www.google.com’ and it may cause delay; to reduce this delay, storing, the IP address for ‘www.google.com’ in the search rule information DB in advance and using the IP address, e.g. ‘http://74.125.127.103’ instead of ‘http://www.google.com’, can be considered. However, in this scheme, users may have difficulty in discerning if the current site is an original site or a phishing site.

There are 3 methods of implementing how to show search results for user's query: a method of using a redirection message, a method of generating and transferring a result page template, and a method of reorganizing, a result page as a proxy.

Firstly, the method of using a redirection message is the easiest method and is processed by the redirection module. As exemplified previously, in this method, the user's query ‘mp3 at google’ is translated into the URL ‘http://www.google.com/search?query=mp3’ and redirected to Google. The advantages of this method are reduced load for the query analysis system and easiness of creating search rules for users. However, it is hard to reorganize the search results according to user's needs (Needs).

Secondly, the method of generating and transferring a result page template supports the reorganization of the search results while minimizing the load of the query analysis system, and is processed by the template module. For example, when the result page consists of 3 frame areas, the first area displays advertisements from Overture (www.overture.com), the second area displays the search results from Google, and the third page displays the search results from Naver (www.naver.com). For this method, public API (Application Programming Interface) is usually used.

Lastly, the method of reorganizing a result page as a proxy can reorganize the result page as needed though the load for the query analysis system is higher; it is processed by the proxy module. Different from the method of generating and transferring a result page template, which only divides the display area into multiple frames and filling in frames is done by the browser, the method of reorganizing a result page as a proxy let the query analysis system provide the contents in frames as well as the frame structure. Thus, though the load for the query analysis system increases it is possible to reorganize the search result as much as needed. The query analysis system according to the present invention is characterized by being able to use the proper one among all 3 supported methods, according to users' needs.

FIG. 2 illustrates a diagram of processing a query inputted in the address bar by the query analysis system using the redirection method. In the case of the query inputted in the address bar, it is transferred to DNS (Domain Name Service) server to verify if the query is a valid address. If the query is a valid address, it responses with the converted IP address and the client is redirected to the IP address; if the query is not a valid address, it responses with the message saying that the query is not an address and the client performs a search with the default search engine of the browser.

In this case, the default search engine can be set by the user; if the query analysis system is specified as the default search engine, the query analysis system analyzes the input query and sends the redirection message which redirects the browser to a proper service server. In addition, by storing the analyzed input query in an internal or external log DB during this process, the stored data can be used for creation of the search word recommendation DB and the search rule recommendation DB, generation of statistics for popular search words, and so on. If the user uses the instant search window of a browser or the search window on a web page instead of the address bar, the third process (sending the input query to the default search engine) of FIG. 2 will be the first process without doing the first (DNS server request) and the second (DNS server response) process.

Though the above query can be inputted through either the search window on a web page located in the server where the query analysis system is implemented or the search window linked from an external server, if the query is inputted through the address bar or the instant search window of the browser, as described above, the use of the query analysis system will be greatly increased. In addition, it is possible to receive the query from either the search tool bar of portal sites like Yahoo (Yahoo) and Naver or the search window of operating system like Windows 7. In short, the query analysis system can be operated with any type of search window.

In addition, though the query analysis system can be implemented in a new site different from the current search engine sites or service sites, it can also be integrated into the current search engines.

FIG. 3 illustrates a diagram of processing a query inputted in the address bar by the query analysis system using the method of generating and transferring a result page template. Different form the method of generating a redirection message in FIG. 2, when this method is used, it is possible to reorganize the result in the client by getting search results from multiple servers. The query analysis system sends the client the result page template and the client accesses each server to fill in each frame in the template.

FIG. 4 illustrates a diagram of processing a query inputted in the address bar by the query analysis system using the method of reorganizing a result page as a proxy. Different form the method of generating a result page template in FIG. 3, when we reorganize a result page as a proxy, it is not the client but the query analysis system to send a query to each server and reorganize the result page. Thus, it is characterized by being able to reorganize the search results as needed.

FIG. 5 illustrates a flowchart diagram of the query analysis system. Firstly, search word recommendation is performed for the inputted query, and search rule recommendation is performed after the search word recommendation. Then, the settings information restoration process is performed and the default search rule or the separator is selected for the user and the search window. If there is a designated command in the analyzed query, a pre-defined job is performed for the command; if the command is in the form of ‘go shortcutname’, URL restoration is performed using the shortcut information DB.

After the command analysis, the existence of a separator is checked; if there is no separator, message generation such as the URL restoration and the code generation is performed for the user and the search window; if a search rule is specified, the search rule is checked if it is registered or not. In this process, if the search rule is registered, a message such a as a URL and a code is generated based on the search rule: if the search as is rule is not registered, the URL for a new search rule registration page is selected to redirect the user to the page.

The message generated with the search rule is transferred differently based on which method is used among the proxy method, the template method, and the redirection method. If the proxy method is selected, the proxy module of the query analysis system transfers the search word to the servers specified in the message, reorganize the result and display it to the user screen. When displaying it, the possible display methods are: displaying at the current window, displaying at a new window, displaying at a popup window, and so on; the preferred display method can be stored in the personal settings information DB per user or in the search rule information DB. In addition, the second separator such as ‘to’ can be used to specify a display method in a input query; ‘mp3 at google to new’ may mean searching ‘mp3’ with the search rule ‘google’ and displaying the result to a new window.

If the display method is not the proxy method, the template method is checked; if the display method is the template method, a result page template is generated and transferred to the browser and the browser does the rest of the process.

If the display method is neither the template method nor the proxy method, the redirection method is selected; the redirection method is the simplest method; if the restored URL is transferred to the browser, the browser accesses the URL.

FIG. 6 is a flowchart diagram of selecting a search rule; it illustrates in detail the process of checking the existence of the separator and selecting a search rule while checking the existence of a search rule.

Firstly, if there is no separator in the input query, the query should be searched using the default search rule; to select the default search rule, the existence of the default search rule of the search window is checked first and if there is one, that rule is selected as the default search rule; if there is no default search rule for the search window, user's default search rule is selected as the default search rule. If it is not possible to identify the user or he has not specified his default search rule, the global default search rule is selected. At this step, different search rules can be specified for different regions; for example, Naver, the most popular search engine in Korea, may be selected for Korea and Google may be selected for other regions.

In the case that there is a search rule in an input query and the rule is registered, if there are more than one search rules, having the name of that search rule, it is checked if the user has already adopted one among them; if it is the case, the adopted search rule is selected; if it is not, a search rule is selected based on user's search rule selection criterion. If the user's selection criterion is highest reputation, the search rule with the highest reputation is selected among the rules having the same name; if the user's selection criterion is highest usage, the search rule with the highest usage is selected among the rules having the same name. In addition, if the user's selection criterion is highest adoption, the search rule with the highest adoption count is selected among the rules having the same name; if the user's selection criterion is sponsored, the search rule with a sponsor is selected among the rules having the same name. For example, when there are two search rules having the name ‘a’, each from Amazon (www.amazon.com) and About (www.about.com), if About pays sponsoring fee for the name ‘a’, About's search rule will be selected even though Amazon's rule has been used more.

FIG. 7 illustrates an example of two step recommendation of search words and search rules in the query analysis system. When a user inputs ‘m’ in a search window, the query recommendation module looks up search word recommendation DB and displays multiple search words starting with ‘m’; at this step, there can be a sponsor area in the top of the display area where sponsor's search words are displayed. If one of the recommended search words is selected, search rules for the search word are recommended by looking up the search rule recommendation DB. It is possible by analyzing the number of associations between search words and search rules in the logs stored in the log DB and can be implemented with AJAX (Asynchronous. Java Script and XML). Even in the case of the search rule recommendation, sponsor's search rule can be displayed at the top of the search rule recommendation area. Based on the stored number of times sponsor's search words and search rules are recommended in the search word recommendation DB and the search rule recommendation DB, sponsor may pay for the recommendation fee.

When search words and search rules are recommended, the number of associations between search words and search rules can be used; most commonly used search words or search rules per user or per search window can also be used for recommendation.

Each of the two steps can be performed separately or together. In short, the search word recommendation can be provided solely as in most other search engines; the search rule recommendation can also be provided solely; or both recommendations can be provided together. In addition, when a user selects sponsor's search word or search rule, a sponsor may pay for the recommendation fee.

FIG. 8 illustrates examples of processed queries by the search window service system. The search rule information DB has the columns search rule name and search rule ID, which is unique to every search rule. In addition, there are columns like reputation, usage, adoption count, and existence of sponsor, which are used as selection criteria; there is a column describing the action caused by the search rule, usually represented with a URL or a code; there is also the IP address of the service server to reduce the step of the DNS look up.

The personal settings information DB contains user's default search rule ID, adopted search rule ID, selection criterion, separator, use of IP address, and so on.

The first query ‘mp3’ has no specified search rule; a search is performed using user's default search rule, google, whose ID is 100321. The name of the search rule of the second query ‘mp3 at google’ is google; among the search rules having the name google, the search rule with the ID 100321 is used for the second query; since the user has not adopted a search rule with the name a, for the third query ‘ma3 at a’, the search rule with the ID 234322 is selected based on the user's selection criterion, ‘highest usage’. In the fourth query ‘mp3>>ebay’, ‘>>’ is the separator the user has selected and the search rule with the ID 312134 having the name ebay is selected; in the case of the fifth query ‘mp3 [symbol] a’, the search with the query ‘mp3 [symbol] a’ is performed using the default search rule of the ID 100321, since the user has not selected ‘ [symbol] ’ as his separator. When the separator like at is a part of search words, the separator can be escaped with some special characters like double quotation marks; for example, in the query ‘education “at” Harvard at google’, the first at is not a separator.

### INDUSTRIAL APPLICABILITY

The present invention has the purpose of providing a customized service with service variety and extensibility by enabling users to register search rules and shortcuts.

In addition, the present invention has the purpose of enabling users to find needed information faster by recommending search words and search rules related to the input query.

The purposes and advantages of the present invention are clarified by the description and the example embodiment of the present invention. In addition, it is clear that the purposes and advantages of the present invention can be implemented by combining the systems and the methods in the claims.

1. A search window service system, comprising:
a search word recommendation DB utilized to recommend a search word associated with a query inputted by a user, a search rule recommendation DB utilized to recommend a search rule in association with the inputted search word, a persona settings information DB storing settings information on a user basis, a search window information DB storing settings information for every search window, a search rule information DB enabling direct registration by users, and a shortcut information DB enabling direct registration by the users;
a query recommendation module which helps to input a search word and a search rule for the inputted query based on the search word recommendation DB and the search rule recommendation DB;
a setup information restoration module which classifies and restores the query on an element basis based on the personal settings information DB and the search window information DB;
a instruction analysis module which checks Whether the classified and restored query is a command and constructs a message to perform a relevant command;
a message restoration module which converts the query, classified and restored through the setup information restoration module or the instruction analysis module, into the message based on the search rule information DB and the shortcut information DB;
a redirection module which redirects the message, generated from the message restoration module or the instruction analysis module, to the user in a redirection manner;
a template module which returns the message, generated from the message restoration module, to the user in a template manner; and
a proxy module which returns the message, generated from the message restoration module, to the user in a proxy manner.

2. The search window service system as claimed in claim 1, wherein:
‘at’ is registered with the personal settings information DB as a default separator, and
symbols, such as ‘>>’, or letters, such as ‘ [symbol] ’, can be registered with the personal settings information DB according to user selection.

3. The search window service system as claimed in claim 1, wherein the query recommendation module comprises the steps of:
displaying a search word or a search rule, having a sponsor, at the top of a recommendation area based on the search word recommendation DB or the search rule recommendation DB in order to induce user selection; and
when a user selects the search word or the search rule, storing the number of times of selection in the search word recommendation DB or the search rule recommendation DB on a sponsor basis.

4. A method of providing search window service, comprising:
an input step of receiving a query from a user;
a settings information restoration step of classifying and restoring a completed query on an element basis based on a personal settings information DB and a search window information DB;
a message restoration step of restoring the classified and restored query into a message based on a search rule information DB; and
a step of returning the restored message to the user.

5. The method as claimed in claim 4, wherein the input step comprises the step of receiving the completed query through the steps of:
in the case that a search word recommended by a search word recommendation DB is selected in relation to a query inputted by the user or the input query includes only the search word,
when search rules including a separator are recommended based on a search rule recommendation DB,
if a default search rule registered with the personal settings information DB is selected among the recommended search rules, inputting the default search rule;
if an adoption rule registered with the personal settings information DB is selected among the recommended search rules, inputting the relevant adoption rule;
if a search rule other than the default search rule or the adoption rule is selected among the recommended search rules, inputting a search rule complying with a selection criterion registered with the personal settings information DB; and
if any one of the recommended search rules is not selected, inputting the default search rule.

6. The method as claimed in claim 4, wherein the settings information restoration step comprises the steps of:
if a command is included in the restored query and the command is a shortcut command by analyzing the command, executing the shortcut command based on a shortcut information DB; and
if the command is a command other than a shortcut command, executing the relevant command.

7. The method as claimed in claim 4 or 5, wherein the settings information restoration step comprises:
a step of, if the restored query does not include a separator and the default search rule set in the search window information DB exists in a search window, selecting the default search rule set in the search window;
a step of, if the restored query does not include a separator and the default search rule does not exist in the search window, selecting the user's default search rule set in the personal settings information DB;
a step of, if the restored query does not include a separator, the default search rule does not exist in the search window, and a user's default search rule is not set in the personal settings information DB, selecting a global default search rule;
a message restoration step of, if the restored query includes a separator and a search rule next to the separator is not registered with the search rule information DB, restoring a message with the URL to the page where a new search rule is registered;
a step of, if the restored query includes a separator, a search rule next to the separator is registered with the search rule information DB, and the relevant search rifle selected by the user is stored in the personal settings information DB, selecting the search rule selected by the user: and
a step of, if the restored query includes a separator, a search rule next to the separator is registered with the search rule information DB, and the user did not adopt the search rule, selecting a search rule based on a search rule selection criterion stored in the personal settings information DB.

8. The method as claimed in claim 7, wherein the step of returning the restored message to the user comprises the steps of:
transmitting the search word from a search window service system to service servers, receiving responses and reorganize the responses, and transmitting the reorganized result to a screen of the user in a proxy manner;
generating and transmitting a template, directly receiving the responses from the service servers through a computer of the user, and displaying the result on the screen of the user in a template manner; and
restoring the URL according to the search rule and displaying the restored URL on the screen of the user.

9. The method as claimed in claim 4 or 6, wherein the message restoration step comprises the step of substituting a server address part of the URL with an IP address based on the personal settings information DB and transmitting the IF address.
